(19) United States
(12) Patent Application Publication
(10) Pub. No.: US 2024/0196157 A1
(43) Pub. Date: Jun. 13, 2024

(54) WIRELESS EARPHONES AND PASS-THROUGH METHOD, APPARATUS AND SYSTEM THEREFOR

(71) Applicant: GOERTEK INC., Weifang, Shandong (CN)

(72) Inventors: Liguo LIU, Weifang, Shandong (CN); Fenqing WANG, Weifang, Shandong (CN)

(21) Appl. No.: 18/556,366

(22) PCT Filed: Sep. 28, 2021
(86) PCT No.: PCT/CN2021/121249

§ 371 Date: Oct. 20, 2023

(30) Foreign Application Priority Data
Apr. 30, 2021 (CN) 202110482957.4

(51) Int. Cl. H04S 7/00; H04R 1/10; H04R 5/027; H04R 5/033

(52) U.S. Cl. CPC H04S 7/304; H04R 1/1016; H04R 1/1041; H04R 5/027; H04R 5/033; H04R 2420/07; H04S 2400/11; H04S 2400/15

(57) ABSTRACT

Disclosed are a pass-through method, apparatus and system for wireless earphones and a computer-readable storage medium, which are applied to an earphone in wireless earphones, and the earphone is provided with a main microphone and a feedforward microphone. The method includes: acquiring a first main sound signal and a first feedforward sound signal respectively picked up by the main and feedforward microphones; receiving second main and feedforward sound signals sent by the other earphone, the second main and feedforward sound signals being picked up by main and feedforward microphones disposed on the other earphone; obtaining orientation information of a sound source relative to a wearer of the earphones according to the first main and feedforward sound signals, and the second main and feedforward sound signals; and controlling speakers of the wireless earphones to play a sound having a corresponding sound effect according to the orientation information.

The present disclosure claims the priority to the Chinese Patent Application No. 202110482957.4, entitled “WIRELESS EARPHONES AND PASS-THROUGH METHOD, APPARATUS AND SYSTEM THEREFOR” filed with China Patent Office on Apr. 30, 2020, the entire contents of which are incorporated into the present disclosure by reference.

### TECHNICAL FIELD

Embodiments of the present disclosure relate to the technical field of earphones, and particularly, to wireless earphones and pass-through method, apparatus, and system therefor.

### DESCRIPTION OF RELATED ART

With the development of wireless earphone technology, TWS earphones are more and more loved by consumers. In general, in-ear TWS earphones have functions such as music playback, calling, noise reduction, and pass-through.

At present, the pass-through function of existing in-ear TWS earphones is mainly implemented by picking up a sound of surrounding environment through a feedforward (FF) MIC of the earphones, superimposing it to an audio channel through analog-to-digital conversion of a Codec and processing of a Digital Signal Processing (DSP), and then restoring the sound in the environment to a wearer through a speaker of the earphones. However, with the continuous increase of user needs, when the TWS earphones in the related art restore the sound in the environment to the wearer through the speaker, the wearer cannot distinguish the specific orientation of a sound source from the sound played by the speaker of the TWS earphones, making it difficult to meet the needs of users.

In view of this, how to provide wireless earphones and pass-through method, apparatus and system therefor to solve the above technical problems has become a problem to be solved by those skilled in the art.

### SUMMARY

An object of embodiments of the present disclosure is to provide wireless earphones and pass-through method, apparatus and system therefor, which can enable a wearer of the earphones to distinguish the orientation of the sound source relative to himself according to the sound effect heard during use, further meeting user needs and improving user experience.

In order to solve the above technical problem, an embodiment of the present disclosure provides a pass-through method for wireless earphones, wherein the method is applied to an earphone in wireless earphones, and the earphone is provided with a main microphone and a feedforward microphone. The method includes:
acquiring a first main sound signal picked up by the main microphone and a first feedforward sound signal picked up by the feedforward microphone;
receiving a second main sound signal and a second feedforward sound signal sent by the other earphone, the second main sound signal being picked up by a main microphone disposed on the other earphone, and the second feedforward sound signal being picked up by a feedforward microphone disposed on the other earphone;
obtaining, according to the first main sound signal, the first feedforward sound signal, the second main sound signal and the second feedforward sound signal, orientation information of a sound source relative to a wearer of the earphones; and
controlling, according to the orientation information, speakers of the wireless earphones to play a sound having a corresponding sound effect.

Optionally, obtaining, according to the first main sound signal, the first feedforward sound signal, the second main sound signal and the second feedforward sound signal, orientation information of a sound source relative to a wearer of the earphones, includes:
extracting a first useful sound signal, a second useful sound signal, a third useful sound signal and a fourth useful sound signal corresponding to the sound source from the first main sound signal, the first feedforward sound signal, the second main sound signal and the second feedforward sound signal, respectively; and
comparing the first useful sound signal, the second useful sound signal, the third useful sound signal and the fourth useful sound signal and determining the orientation information of the sound source relative to the wearer of the earphones according to comparison results.

Optionally, comparing the first useful sound signal, the second useful sound signal, the third useful sound signal and the fourth useful sound signal, and determining the orientation information of the sound source relative to the wearer of the earphones according to comparison results, includes:
when both the first useful sound signal and the second useful sound signal are greater than the third useful sound signal and the fourth useful sound signal, determining that the sound source is on an earphone side if a first difference of the first useful sound signal and the second useful sound signal is less than a first preset value, that the sound source is located between the earphone side and the front side of the wearer if the first difference is greater than a second preset value and the first useful sound signal is greater than the second useful sound signal; and that the sound source is located between the earphone side and rear side of the wearer if the first difference is greater than the second preset value and the second useful sound signal is greater than the first useful sound signal; and
when both the first useful sound signal and the second useful sound signal are smaller than the third useful sound signal and the fourth useful sound signal, determining that the sound source is on the other earphone side if a second difference of the third useful sound signal and the fourth useful sound signal is less than a first preset value, that the sound source is located between the other earphone side and the front side of the wearer if the second difference is greater than the second preset value and the third useful sound signal is greater than the fourth useful sound signal, and that, the sound source is located between the other earphone side and rear side of the wearer if the second difference is greater than the second preset value and the third useful sound signal is smaller than the fourth useful sound signal.

Optionally, controlling, according to the orientation information, speakers of the wireless earphones to play a sound having a corresponding sound effect, includes:
determining a target sound effect signal according to the orientation information and pre-established correspondence between the orientation information and a sound effect signal; and
controlling the speakers of the wireless earphones to play the sound having a corresponding sound effect according to the target sound effect signal.

Optionally, controlling, according to the orientation information, speakers of the wireless earphones to play a sound having a corresponding sound effect, includes:
analyzing the orientation information by using a spatial sound effect algorithm to obtain a corresponding target sound effect signal; and
controlling the speakers of the wireless earphones to play the sound having a corresponding sound effect according to the target sound effect signal.

Optionally, when the sound source is on the earphone side, the process of controlling the speakers of the wireless earphones to play the sound having a corresponding sound effect according to the target sound effect signal includes:
controlling the speakers of the wireless earphones to play the sound having a corresponding sound effect according to the target sound effect signal, and making the sound of the speaker on the earphone side louder than the sound of the speaker on the other earphone side; and
when the sound source is on the other earphone side, the process of controlling the speakers of the wireless earphones to play the sound having a corresponding sound effect according to the target sound effect signal includes:
controlling the speakers of the wireless earphones to play the sound having a corresponding sound effect according to the target sound effect signal, and making the sound of the speaker on the earphone side quieter than the sound of the speaker on the other earphone side.

Optionally, the method further includes, before controlling the speakers of the wireless earphones to play the sound having a corresponding sound effect according to the target sound effect signal:
obtaining an environmental noise signal according to the first main sound signal, the first feedforward sound signal, the second main sound signal and the second feedforward sound signal; and
mixing the target sound effect signal and the environmental noise signal according to preset weights to obtain a mixed sound signal; and
the process of controlling the speakers of the wireless earphones to play the sound having a corresponding sound effect according to the target sound effect signal includes:
controlling the speakers of the wireless earphones to play the sound having a corresponding sound effect according to the mixed sound signal.

An embodiment of the present disclosure also provides a pass-through apparatus for wireless earphones, wherein the apparatus is applied to an earphone in wireless earphones, and the earphone is provided with a main microphone and a feedforward microphone. The apparatus includes:
an acquisition module configured to acquire a first main sound signal picked up by the main microphone and a first feedforward sound signal picked up by the feedforward microphone;
a receiving module configured to receive a second main sound signal and a second feedforward sound signal sent by the other earphone, the second main sound signal being picked up by a main microphone disposed on the other earphone, and the second feedforward sound signal being picked up by a feedforward microphone disposed on the other earphone;
an analysis module configured to obtain orientation information of a sound source relative to a wearer of the earphones according to the first main sound signal, the first feedforward sound signal, the second main sound signal and the second feedforward sound signal; and
a playing module configured to control speakers of the wireless earphones to play a sound having a corresponding sound effect according to the orientation information.

An embodiment of the present disclosure also provides a pass-through system for wireless earphones, wherein the system is applied to each earphone of wireless earphones, and the system includes main microphone, a feedforward microphone, a memory, and a processor disposed on the earphone, wherein:
the memory is configured to store computer program; and
the processor is configured to implement steps of the pass-through method for wireless earphones as described above when executing the computer program.

An embodiment of the present disclosure also provides wireless earphones including a left earphone and a right earphone, and the pass-through system for wireless earphones, as described above, disposed on each of the left earphone and the right earphone.

Embodiments of the present disclosure provide pass-through method, apparatus and system for wireless earphones, and computer-readable storage medium, which are applied to an earphone in wireless earphones. The earphone is provided with a main microphone and a feedforward microphone. The method includes obtaining orientation information of a sound source relative to a wearer of the earphones according to the first main sound signal picked up by the main microphone and the first feedforward sound signal picked up by the feedforward microphone and the second main sound signal and the second feedforward sound signal sent by the other earphone, and then controlling speakers of the wireless earphones to play a sound having a corresponding sound effect according to the orientation information. That is, different orientation information corresponds to different sound effects, so that a wearer of the earphones can distinguish the orientation of the sound source relative to himself according to the sound effect heard during use, thereby further meeting user needs and improving user experience.

### BRIEF DESCRIPTION OF DRAWINGS

In order to more clearly illustrate the technical solutions of the present disclosure, the drawings required to be used for the content of the embodiments or the prior art will be briefly introduced in the following. Obviously, the drawings in the following description are some embodiments of the present disclosure, and for those of ordinary skill in the art, other drawings can also be obtained from the provided drawings without any creative effort.

FIG. 1 is a schematic flowchart of a pass-through method for wireless earphones according to an embodiment of the present disclosure;

FIG. 2 is a schematic diagram of wearing wireless earphones according to an embodiment of the present disclosure;

FIG. 3 is a schematic diagram of wearing wireless earphones according to another embodiment of the present disclosure;

FIG. 4 is a schematic structural diagram of a pass-through apparatus for wireless earphones according to an embodiment of the present disclosure.

### DETAILED DESCRIPTIONS

Embodiments of the present disclosure provide wireless earphones and pass-through method, apparatus and system therefor, which can enable a wearer of the earphones to distinguish the orientation of the sound source relative to himself according to the sound effect heard during use, further meeting user needs and improving user experience.

In order to make the purpose, technical solutions and advantages of the embodiments of the present disclosure clearer, the technical solutions of embodiments of the present disclosure will be described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

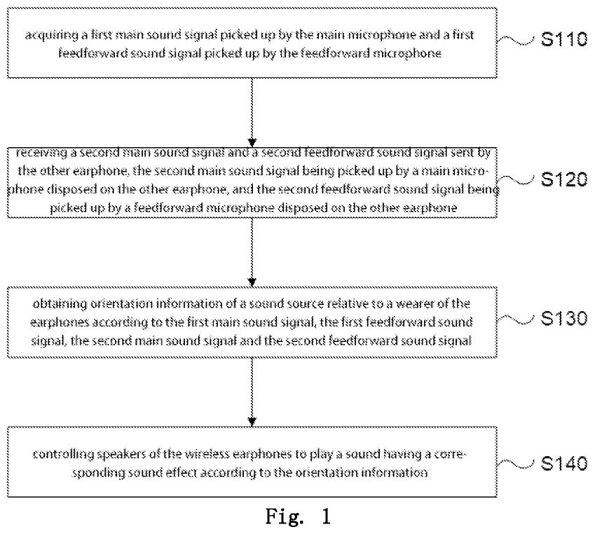

Referring to FIG. 1, FIG. 1 is a schematic flowchart of a pass-through method for wireless earphones according to an embodiment of the present disclosure. The method is applied to an earphone in wireless earphones, and the earphone is provided with a main microphone and a feedforward microphone. The method includes:

S110: acquiring a first main sound signal picked up by the main microphone and a first feedforward sound signal picked up by the feedforward microphone.

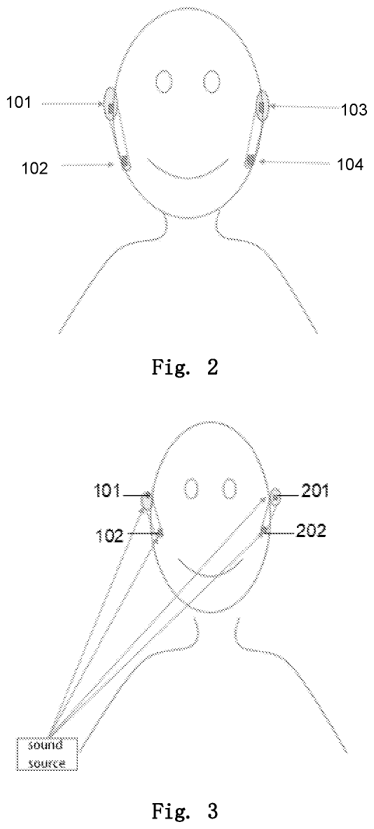

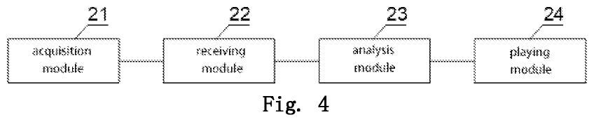

It should be noted that the earphone of the wireless earphones in the embodiment of the present disclosure is provided with a main microphone and a feedforward microphone, wherein the main microphone is provided at a lower end of the earphone near the mouth when worn, and the feedforward microphone is provided at an ear end of the earphone. Specifically, main microphones and feedforward microphones may be provided on both the left and right earphones of the wireless earphones. After wearing the wireless earphones, as illustrated in FIG. 2, a feedforward microphone 101 and a main microphone 102 are disposed on the right earphone, and a feedforward microphone 201 and a main microphone 202 are disposed on the left earphone.

S120: receiving a second main sound signal and a second feedforward sound signal sent by the other earphone, the second main sound signal being picked up by a main microphone disposed on the other earphone, and the second feedforward sound signal being picked up by a feedforward microphone disposed on the other earphone.

Specifically, in the embodiment of the present disclosure, for one earphone, the first main sound signal and the first feedforward sound signal picked up by the main microphone and the feedforward microphone on the earphone can be obtained, and the second main sound signal and the second feedforward sound signal picked up by the main microphone and the feedforward microphone on the other earphone and sent by the other earphone can be received.

For example, for the right earphone, the feedforward sound signal and the main sound signal picked up by 101 and 102, respectively, can be obtained, and the feedforward sound signal and the main sound signal picked up by 201 and 202 on the left earphone and sent by the left earphone are received; for the left earphone, the feedforward sound signal and the main sound signal picked up by 201 and 202 can be obtained, and the feedforward sound signal and the main sound signal respectively picked up by 101 and 102 on the right earphone and sent by the right earphone can be received.

S130: obtaining, according to the first main sound signal, the first feedforward sound signal, the second main sound signal and the second feedforward sound signal, orientation information of a sound source relative to a wearer of the earphones.

Specifically, a first useful sound signal, a second useful sound signal, a third useful sound signal and a fourth useful sound signal corresponding to the sound source may be extracted from the first main sound signal, the first feedforward sound signal, the second main sound signal and the second feedforward sound signal, respectively; and the first useful sound signal, the second useful sound signal, the third useful sound signal and the fourth useful sound signal are compared and the orientation information of the sound source relative to the wearer of the earphones can be determined according to comparison results.

Specifically, a pass frequency band range of a band pass filter can be set. For example, the pass frequency band of the band pass filter may be set as a preset frequency band according to actual situations, and a first useful sound signal, a second useful sound signal, a third useful sound signal and a fourth useful sound signal corresponding to the sound source may be extracted from the first main sound signal, the first feedforward sound signal, the second main sound signal and the second feedforward sound signal, respectively. Specifically, each useful sound signal may be a human voice signal, and when it is a human voice signal, the pass frequency band of the band pass filter may be set to 20-10 KHz. As illustrated in FIG. 3, since the distances from the sound source to different microphones are different, the strength of each useful sound signal is also different. Therefore, by comparing the useful sound signals according to the magnitude of signal strength, the comparison results are obtained, and according to the comparison results, the orientation information of the sound source relative to the wearer of the earphones can be obtained.

Furthermore, comparing the first useful sound signal, the second useful sound signal, the third useful sound signal and the fourth useful sound signal, and determining the orientation information of the sound source relative to the wearer of the earphones according to comparison results, may specifically include:
when both the first useful sound signal and the second useful sound signal are greater than the third useful sound signal and the fourth useful sound signal, determining that the sound source is on an earphone side if a first difference of the first useful sound signal and the second useful sound signal is less than a first preset value, that the sound source is located between the earphone side and the front side of the wearer if the first difference is greater than a second preset value and the first useful sound signal is greater than the second useful sound signal; and that the sound source is located between the earphone side and rear side of the wearer if the first difference is greater than the second preset value and the second useful sound signal is greater than the first useful sound signal; and
when both the first useful sound signal and the second useful sound signal are smaller than the third useful sound signal and the fourth useful sound signal, determining that the sound source is on the other earphone side if a second difference of the third useful sound signal and the fourth useful sound signal is less than a first preset value, that the sound source is located between the other earphone side and the front side of the wearer if the second difference is greater than the second preset value and the third useful sound signal is greater than the fourth useful sound signal, and that, the sound source is located between the other earphone side and rear side of the wearer if the second difference is greater than the second preset value and the third useful sound signal is smaller than the fourth useful sound signal.

For example, when the useful sound signals corresponding to 101 and 102 are greater than the useful sound signals corresponding to 201 and 202, and the difference between the useful sound signals corresponding to 101 and 102 is less than the first preset value, it means that the difference between the useful sound signals corresponding to 101 and 102 is relatively smaller, so that it can be determined that the sound source is on the right earphone side. On the contrary, when the useful sound signals corresponding to 201 and 202 are larger than the useful sound signals corresponding to 101 and 102, and the difference between the useful sound signals corresponding to 201 and 202 is less than the first preset value, it means that the difference between the useful sound signals corresponding to 201 and 202 is relatively smaller, so that it can be determined that the sound source is on the left earphone side.

In addition, since the earphones are in a tilted state when the earphones are worn, if the useful sound signals corresponding to 101 and 102 are greater than the useful sound signals corresponding to 201 and 202, and the difference between the useful sound signals corresponding to 101 and 102 is greater than the second preset value, it means that the difference between the useful sound signals corresponding to 101 and 102 is relatively larger, and in this case, the sound source is shifted relative to the right side. If the useful sound signal corresponding to 101 is larger, it means that the sound source is at the rear right side, and if the useful sound signal corresponding to 102 is larger, it means that the sound source is at the front right side. On the contrary, if the useful sound signals corresponding to 101 and 102 are smaller than the useful sound signals corresponding to 201 and 202, and the difference between the useful sound signals corresponding to 201 and 202 is greater than the second preset value, it means that the difference between the useful sound signals corresponding to 201 and 202 is relatively larger, and in this case, the sound source is shifted relative to the left side. If the useful sound signal corresponding to 201 is larger, it means that the sound source is at the rear left side, and if the useful sound signal corresponding to 202 is larger, it means that the sound source is at the front left side.

S140: controlling, according to the orientation information, speakers of the wireless earphones to play a sound having a corresponding sound effect.

Specifically, after determining the orientation information of the sound source relative to the earphone wearer, the speakers of the wireless earphones can be controlled to play a sound having a corresponding sound effect according to the orientation information. That is, different sound effects are played according to different orientation information, so that users can identify the orientation of the sound source based on the sound effect they hear.

Specifically, in order to better restore the external sound, in the embodiment of the present disclosure, the method may further include, before controlling the speakers of the wireless earphones to play the sound having a corresponding sound effect according to the target sound effect signal:
obtaining an environmental noise signal according to the first main sound signal, the first feedforward sound signal, the second main sound signal and the second feedforward sound signal; and
mixing the target sound effect signal and the environmental noise signal according to preset weights to obtain a mixed sound signal; and
the process of controlling the speakers of the wireless earphones to play the sound having a corresponding sound effect according to the target sound effect signal includes:
controlling the speakers of the wireless earphones to play the sound having a corresponding sound effect according to the mixed sound signal.

It will be understood that since the sound signal picked up by each microphone includes both human voice and ambient sound, an environmental noise signal can be extracted according to the first main sound signal, the first feedforward sound signal, the second main sound signal and the second feedforward sound signal. Then, the obtained target sound signal and environmental noise signal are mixed according to preset weights to obtain a mixed sound signal, and the mixed sound signal is played through a speaker. The mixed sound signal includes both human voice and environmental noise, so that the sound in the external environment can be better restored. The preset weights can be pre-set according to actual situations, and it is not limited in the embodiments of the present disclosure.

Further, the process of controlling speakers of the wireless earphones to play a sound having a corresponding sound effect according to the orientation information in S140 may specifically include:
determining a target sound effect signal according to the orientation information and pre-established correspondence between the orientation information and a sound effect signal; and
controlling the speakers of the wireless earphones to play the sound having a corresponding sound effect according to the target sound effect signal.

It should be noted that, in the embodiment of the present disclosure, the correspondence between the orientation information of the sound source in different orientations and the corresponding sound effect signal can be pre-established based in advance upon the positions of the first main microphone, the first feedforward microphone, the second main microphone and the second feedforward microphone on the two earphones relative to the earphone wearer after wearing the wireless earphones. After the specific orientation information of the sound source is determined during the actual use of the wireless earphones, a corresponding target sound effect signal is matched up according to the orientation information and the pre-established correspondence, and then the speakers of the wireless earphones are controlled to play the sound having a corresponding sound effect according to the target sound effect signal.

Further, the process of controlling speakers of the wireless earphones to play a sound having a corresponding sound effect according to the orientation information in S140 may also specifically include:
analyzing the orientation information by using a spatial sound effect algorithm to obtain a corresponding target sound effect signal; and
controlling the speakers of the wireless earphones to play the sound having a corresponding sound effect according to the target sound effect signal.

It should also be noted that, in practical applications, it is not limited to pre-establishing the correspondence between the orientation information and the sound effect signal. It may also be possible to directly use the spatial sound effect algorithm to analyze the orientation information after the orientation information is obtained during the use of the wireless earphones, and then to obtain the corresponding target sound effect signal.

Further, when the sound source is on the earphone side, the process of controlling the speakers of the wireless earphones to play the sound having a corresponding sound effect according to the target sound effect signal includes:
controlling the speakers of the wireless earphones to play the sound having a corresponding sound effect according to the target sound effect signal, and making the sound of the speaker on the earphone side louder than the sound of the speaker on the other earphone side.

When the sound source is on the other earphone side, the process of controlling the speakers of the wireless earphones to play the sound having a corresponding sound effect according to the target sound effect signal includes:
controlling the speakers of the wireless earphones to play the sound having a corresponding sound effect according to the target sound effect signal and making the sound of the speaker on the earphone side quieter than the sound of the speaker on the other earphone side.

It should be noted that, in the embodiment of the present disclosure, while the speakers of the wireless earphones are controlled to play the sound having a corresponding sound effect according to the target sound effect signal, the distinction between different orientations can be further accentuated by controlling the volume of the left and right earphones. Referring to FIG. 2, when the sound source is on the left earphone side, the volume of the sound played by the left earphone can be controlled to be greater than that of the right earphone; when the sound source is on the right earphone side, the volume of the sound played by the right earphone can be controlled to be greater than that of the left earphone. In addition, when the difference between the useful sound signals corresponding to 101 and 201 is smaller than the first preset value, and both of the useful sound signals corresponding to 101 and 201 are greater than the useful sound signals corresponding to 102 and 202, the sound source is at the rear side of the earphone wearer in this case, and thus, the speakers of the left earphone and the right earphone can be controlled to play the sound having a corresponding sound effect according to the corresponding target sound effect signal to equalize the volume of the sound played by the speakers of the left and right earphones. When both of the useful sound signals corresponding to 101 and 201 are smaller than the useful sound signals corresponding to 102 and 202, and the difference between the useful sound signals corresponding to 101 and 201 is smaller than the first preset value, it means that the sound source is in front side of the earphone wearer, and in this case, the speakers of the left earphone and the right earphone can be controlled to play the sound having a corresponding sound effect according to the corresponding target sound effect signal to equalize the volume of the sound played by the speakers of the left and right earphones.

It can be seen that the pass-through method for wireless earphones provided in the embodiment of the present disclosure is applied to an earphone in wireless earphones. Orientation information of a sound source relative to a wearer of the earphones is obtained according to a first main sound signal picked up by a main microphone and a first feedforward sound signal picked up by a feedforward microphone on the earphone and a second main sound signal and a second feedforward sound signal sent by the other earphone, and speakers of the wireless earphones are then controlled to play a sound having a corresponding sound effect according to the orientation information. That is, different orientation information corresponds to different sound effects, so that a wearer of the earphones can distinguish the orientation of the sound source relative to himself according to the sound effect heard during use, further meeting user needs and improving user experience.

An embodiment of the present disclosure also provides a pass-through apparatus for wireless earphones, wherein the apparatus is applied to an earphone in wireless earphones, and the earphone is provided with a main microphone and a feedforward microphone. Referring to FIG. 3, the apparatus includes:
an acquisition module 21 configured to acquire a first main sound signal picked up by the main microphone and a first feedforward sound signal picked up by the feedforward microphone;
a receiving module 22 configured to receive a second main sound signal and a second feedforward sound signal sent by the other earphone, the second main sound signal being picked up by a main microphone disposed on the other earphone, and the second feedforward sound signal being picked up by a feedforward microphone disposed on the other earphone;
an analysis module 23 configured to obtain orientation information of a sound source relative to a wearer of the earphones according to the first main sound signal, the first feedforward sound signal, the second main sound signal and the second feedforward sound signal; and
a playing module 24 configured to control speakers of the wireless earphones to play a sound having a corresponding sound effect according to the orientation information.

It should be noted that the pass-through apparatus for wireless earphones provided in the embodiment of the present disclosure has the same beneficial effect as the pass-through method for wireless earphones provided in the above-mentioned embodiment and is applicable to the pass-through method for wireless earphones. For the specific introduction of the pass-through method for wireless earphones, please refer to the above embodiment, and it will not be repeated here.

An embodiment of the present disclosure also provides a pass-through system for wireless earphones, wherein the system is applied to each earphone of wireless earphones, and the system includes a main microphone, a feedforward microphone, a memory, and a processor disposed on the earphone, wherein:
the memory is configured to store computer program; and
the processor is configured to implement steps of the pass-through method for wireless earphones as described above when executing the computer program.

For example, the processor in the embodiment of the present disclosure is configured: to obtain the first main sound signal picked up by the main microphone and the first feedforward sound signal picked up by the feedforward microphone; to receive the second main sound signal and the second front sound signal sent by the other earphone, the second main sound signal being picked up by the main microphone disposed on the other earphone, and the second feedforward sound signal being picked up by the feedforward microphone disposed on the other earphone; to obtain the orientation information of the sound source relative to the earphone wearer according to the first main sound signal, the first feedforward sound signal, the second main sound signal and the second feedforward sound signal; and to control speakers of the wireless earphones to play a sound having a corresponding sound effect according to the orientation information.

An embodiment of the present disclosure also provides wireless earphones including a left earphone and a right earphone, and the pass-through system for wireless earphones, as described above, disposed on each of the left earphone and the right earphone.

The various embodiments in this specification are described in a progressive manner, and each embodiment focuses on the differences from other embodiments, and the same or similar parts between the various embodiments may be referred to each other. As for the apparatus disclosed in the embodiment, since it corresponds to the method disclosed in the embodiment, the description is relatively simple. For relevant parts, please refer to the description of the method.

It should be noted that relational terms such as first and second described herein are only used to distinguish one entity or operation from another entity or operation, and do not necessarily require or imply any such actual relationship or order between these entities or operations. Moreover, terms such as “comprise”, “include” or any other variation thereof are intended to encompass a non-exclusive inclusion such that a process, method, article or apparatus that includes a series of elements includes not only those elements, but also other elements not explicitly listed, or elements inherent to such a process, method, article or apparatus. Without further limitation, the element defined by the phrase “comprising a . . . ” does not preclude the presence of additional identical elements in the process, method, article or apparatus including the element.

The above description of the disclosed embodiments enables any person skilled in the art to implement or make use of the present disclosure. Various modifications to these embodiments will be readily apparent to those skilled in the art, and the generic principles defined herein may be implemented in other embodiments without departing from the spirit or scope of the present disclosure. Therefore, this application is not intended to be limited to the embodiments shown herein but is to be accorded the widest scope consistent with the principles and novel features disclosed herein.

1. A pass-through method for wireless earphones, wherein the method is applied to an earphone in wireless earphones, and the earphone is provided with a main microphone and a feedforward microphone, and wherein the method comprises:
acquiring a first main sound signal picked up by the main microphone and a first feedforward sound signal picked up by the feedforward microphone;
receiving a second main sound signal and a second feedforward sound signal sent by the other earphone, the second main sound signal being picked up by a main microphone disposed on the other earphone, and the second feedforward sound signal being picked up by a feedforward microphone disposed on the other earphone;
obtaining, according to the first main sound signal, the first feedforward sound signal, the second main sound signal and the second feedforward sound signal, orientation information of a sound source relative to a wearer of the earphones; and
controlling, according to the orientation information, speakers of the wireless earphones to play a sound having a corresponding sound effect.

2. The pass-through method for wireless earphones of claim 1, wherein obtaining, according to the first main sound signal, the first feedforward sound signal, the second main sound signal and the second feedforward sound signal, orientation information of a sound source relative to a wearer of the earphones, comprises:
extracting a first useful sound signal, a second useful sound signal, a third useful sound signal and a fourth useful sound signal corresponding to the sound source from the first main sound signal, the first feedforward sound signal, the second main sound signal and the second feedforward sound signal, respectively; and
comparing the first useful sound signal, the second useful sound signal, the third useful sound signal and the fourth useful sound signal and determining the orientation information of the sound source relative to the wearer of the earphones according to comparison results.

3. The pass-through method for wireless earphones of claim 2, wherein comparing the first useful sound signal, the second useful sound signal, the third useful sound signal and the fourth useful sound signal, and determining the orientation information of the sound source relative to the wearer of the earphones according to comparison results, comprises:
when both the first useful sound signal and the second useful sound signal are greater than the third useful sound signal and the fourth useful sound signal, determining that the sound source is on an earphone side if a first difference of the first useful sound signal and the second useful sound signal is less than a first preset value, that the sound source is located between the earphone side and front side of the wearer if the first difference is greater than a second preset value and the first useful sound signal is greater than the second useful sound signal; and that the sound source is located between the earphone side and rear side of the wearer if the first difference is greater than the second preset value and the second useful sound signal is greater than the first useful sound signal; and
when both the first useful sound signal and the second useful sound signal are smaller than the third useful sound signal and the fourth useful sound signal, determining that the sound source is on the other earphone side if a second difference of the third useful sound signal and the fourth useful sound signal is less than a first preset value, that the sound source is located between the other earphone side and the front side of the wearer if the second difference is greater than the second preset value and the third useful sound signal is greater than the fourth useful sound signal, and that, the sound source is located between the other earphone side and the rear side of the wearer if the second difference is greater than the second preset value and the third useful sound signal is smaller than the fourth useful sound signal.

4. The pass-through method for wireless earphones of claim 3, wherein controlling, according to the orientation information, speakers of the wireless earphones to play a sound having a corresponding sound effect, comprises:
determining a target sound effect signal according to the orientation information and pre-established correspondence between the orientation information and a sound effect signal; and
controlling the speakers of the wireless earphones to play the sound having a corresponding sound effect according to the target sound effect signal.

5. The pass-through method for wireless earphones of claim 3, wherein controlling, according to the orientation information, speakers of the wireless earphones to play a sound having a corresponding sound effect, comprises:
analyzing the orientation information by using a spatial sound effect algorithm to obtain a corresponding target sound effect signal; and
controlling the speakers of the wireless earphones to play the sound having a corresponding sound effect according to the target sound effect signal.

6. The pass-through method for wireless earphones of claim 1, wherein
when the sound source is on the earphone side, the process of controlling the speakers of the wireless earphones to play the sound having a corresponding sound effect according to the target sound effect signal comprises:
controlling the speakers of the wireless earphones to play the sound having a corresponding sound effect according to the target sound effect signal, and making the sound of the speaker on the earphone side louder than the sound of the speaker on the other earphone side; and
wherein when the sound source is on the other earphone side, the process of controlling the speakers of the wireless earphones to play the sound having a corresponding sound effect according to the target sound effect signal comprises:
controlling the speakers of the wireless earphones to play the sound having a corresponding sound effect according to the target sound effect signal and making the sound of the speaker on the earphone side quieter than the sound of the speaker on the other earphone side.

7. The pass-through method for wireless earphones of claim 4, further comprises, before controlling the speakers of the wireless earphones to play the sound having a corresponding sound effect according to the target sound effect signal:
obtaining an environmental noise signal according to the first main sound signal, the first feedforward sound signal, the second main sound signal and the second feedforward sound signal; and
mixing the target sound effect signal and the environmental noise signal according to preset weights to obtain a mixed sound signal; and
wherein the process of controlling the speakers of the wireless earphones to play the sound having a corresponding sound effect according to the target sound effect signal comprises:
controlling the speakers of the wireless earphones to play the sound having a corresponding sound effect according to the mixed sound signal.

8. A pass-through apparatus for wireless earphones, wherein the apparatus is applied to an earphone in wireless earphones, and the earphone is provided with a main microphone and a feedforward microphone, and wherein the apparatus comprises:
an acquisition module configured to acquire a first main sound signal picked up by the main microphone and a first feedforward sound signal picked up by the feedforward microphone;
a receiving module configured to receive a second main sound signal and a second feedforward sound signal sent by the other earphone, the second main sound signal being picked up by a main microphone disposed on the other earphone, and the second feedforward sound signal being picked up by a feedforward microphone disposed on the other earphone;
an analysis module configured to obtain orientation information of a sound source relative to a wearer of the earphones according to the first main sound signal, the first feedforward sound signal, the second main sound signal and the second feedforward sound signal; and
a playing module configured to control speakers of the wireless earphones to play a sound having a corresponding sound effect according to the orientation information.

9. A pass-through system for wireless earphones, wherein the system is applied to each earphone of wireless earphones, and the system comprises a main microphone, a feedforward microphone, a memory, and a processor disposed on the earphone, wherein:
the memory is configured to store computer program; and
the processor is configured to implement steps of the pass-through method for wireless earphones of claim 1 when executing the computer program.

10. Wireless earphones, comprising a left earphone and a right earphone, and the pass-through system for wireless earphones of claim 9 disposed on each of the left earphone and the right earphone.
